(19) United States
(12) Patent Application Publication
(10) Pub. No.: US 2002/0132907 A1
(43) Pub. Date: Sep. 19, 2002

(54) ACRYLIC POLYMER COMPOSITION

(76) Inventor: MICHAEL STEPHEN CHISHOLM, YARM CLEVELAND (GB)

Correspondence Address: Pillsbury Madison & Sutro LLP, 1100 New York Avenue N.W., Ninth Floor, Washington, DC, 20005-3918, US

(21) Appl. No.: 08/952,351

(22) PCT Filed: May 1, 1996
(86) PCT No.: PCT/GB96/01042

(30) Foreign Application Priority Data
May 22, 1995 (GB) 9510653.0

(51) Int. Cl. C08F 4/00

(52) U.S. Cl. 524/505; 524/547; 526/224

(57) ABSTRACT

An acrylic polymer composition containing: (a) a first amount of a polythiol capped polymer formed by reacting a polythiol of the form (HS-Y)n-X, wherein X is a core group, each Y group is independently a linking group, n is an integer from 3 to 8, preferably from 3 to 6, with at least one mono olefinically unsaturated monomer capable of attaching to and forming a group Z, which is an acrylic polymer chain, on the sulphur atom in each of the groups (HS-Y); and (b) a second amount of a volatile solvent, and wherein the polythiol capped polymer is differentiated from a linear polymer having the same molecular weight as the polythiol capped polymer and which linear polymer is formed from substantially the same each Z group as the polythiol capped polymer in that a first amount of the linear polymer is: (i) not totally solvated by the second amount of volatile solvent; or (ii) when solvated by the second amount of volatile solvent provides a solution which has a viscosity that is at least 25%, preferably at least 30% and especially at least 40%, greater than the viscosity of the first amount of the polythiol capped polymer in the second amount of the volatile solvent. The acrylic polymer composition can be used as a delivery system, particularly for an acrylic polymer with a reduced solvent content thereby reducing solvent emissions to the atmosphere.

The present invention relates to an acrylic polymer composition and in particular an acrylic polymer composition suitable for use as a coating or ink resin.

Inks, coatings, adhesives and similar materials often require the use of a suitable polymer, such as a (meth)acrylate polymer. The polymer is usually used in a delivery system comprising a volatile solvent carrier which in use can be evaporated so as to leave a residue containing the polymer on the desired surface. In some instances the residue is then subjected to further treatment, for example heat treatment, in order to effect additional curing of the residue.

Increasing environmental and legislative pressure make it desirable to reduce the amount of solvent that is used. One option is to increase the polymer content of the delivery system. However, the polymer content can usually not be increased to a significant extent before the solvent becomes saturated with the polymer. Furthermore, merely increasing the polymer content can detrimentally effect the flow properties of the polymer composition such that it is no longer able to be used for its intended purpose.

Alternatively, the polymer may be modified by reducing its average molecular weight. For certain polymers this may be achieved by increasing the amount of chain transfer agent, e.g. a mercaptan, used in the polymerisation process. The lower molecular weight polymer may then be used in increased quantity in the delivery system. Unfortunately, although the flow properties of the polymer composition can be maintained, other key properties then deteriorate, for example a coating formed from the polymer composition tends to become brittle.

A further alternative, is to use a polymer which has a conventional average molecular weight but wherein the range of molecular weights about the average is much narrower, i.e. the dispersivity of the polymer is low. However, the usual methods of preparing such narrow molecular weight distribution polymers, for example as described by J. A. Simms et al, J Coating Technology, Vol 59, No 752, pp 125-131, tend to be expensive and require careful control to limit the presence of contaminants, such as oxygen and water, which can adversely effect the progress of the polymerisation.

A still further alternative is to use a so-called star polymer as described in the reference above. The star polymers therein described are produced through group transfer polymerisation and are high molecular weight, multiarmed polymers that contain tightly crosslinked cores. Such polymers are stated as producing significantly lower viscosity paint when compared with conventional linear resins of comparable molecular weight. However, as discussed above, the described method of group transfer polymerisation is relatively complex.

It has now been found that an acrylic polymer composition containing a relatively higher proportion of acrylic polymer in a volatile solvent can be prepared wherein the acrylic polymer is in the form of a polythiol capped polymer. Such a polythiol capped polymer can be prepared in a relatively facile manner using conventional polymerisation methods using the polythiol as a chain transfer agent. The resulting polymer compositions possess satisfactory flow and other key properties and enable less solvent to be used.

Accordingly in a first aspect, the present invention relates to an acrylic polymer composition containing

(a) a first amount of a polythiol capped polymer formed by reacting a polythiol of the form (HS-Y)ₙ-X wherein X is a core group each Y group is independently a linking group n is an integer from 3 to 8, preferably from 3 to 6 with at least one mono olefinically unsaturated monomer capable of attaching to and forming a group Z, which is an acrylic polymer chain, on the sulphur atom in each of the groups (HS-Y); and

(b) a second amount of a volatile solvent and wherein the polythiol capped polymer is differentiated from a linear polymer having the same molecular weight as the polythiol capped polymer and which linear polymer is formed from substantially the same each Z group as the polythiol capped polymer in that a first amount of the linear polymer is

(i) not totally solvated by the second amount of volatile solvent; or

(ii) when solvated by the second amount of volatile solvent provides a solution which has a viscosity that is at least 25%, preferably at least 30% and especially at least 40%, greater than the viscosity of the first amount of the polythiol capped polymer in the second amount of the volatile solvent.

Typically, the first amount of the polythiol capped polymer and the second amount of volatile solvent are chosen to provide a solution which contains from 20 to 70 g of polythiol capped polymer per 100 g of polythiol capped polymer and volatile solvent, preferably from 30 to 70 g per 100 g and particularly from 40 to 70 g per 100 g. The polythiol capped polymer may also be blended with a least one other polymer with which it is compatible and, when so blended, may be used to provide solutions which contain comparable amounts of the blend as stated above in respect of the polythiol capped polymer.

Preferably the core group, X, is at least part of the residue of a tri- to hexa-functional alcohol such as glycerol, sorbitol, pentaerythritol, dipentaerythritol, tripentaerythritol, trimethylolethane, trimethylolpropane, pentahydroxypentane, triquinoyl and inositol.

Preferably the linking group, Y, is alkylate, particularly C₂₋₁₀ alkylate and especially C₂₋₆, alkylate.

The polythiol capped polymer is preferably formed using a tri- to octa-functional and particularly tri- to hexa-functional mercaptan.

Such a mercaptan may be an ester formed from an alcohol as stated above and a thio-C₂₋₁₀ alkanoic acid, particularly thio-C₂₋₆ alkanoic acid. Examples of suitable acids are 2-mercaptoacetic acid, 2-mercaptopropionic acid, 3-mercaptopropionic acid, 4-mercaptobutyric acid, 5-mercaptopentanoic acid, 6-mercaptohexanoic acid and 10-mercaptodecanoic acid. Preferably the acid is 2-mercaptoacetic acid or 3-mercaptopropionic acid.

Examples of suitable mercaptans include trimethylolethane tris (3-mercaptopropionate), pentaerythritol tetra(3-mercaptopropionate), pentaerythritol tetrathioglycolate, trimethylolethane trithioglycolate, trimethylolpropane tris(3-methcaptopropionate) and trimethylolpropane trithioglycolate.

Typically, the polythiol capped polymer is formed in a process wherein the abovementioned mercaptans are used at levels (by weight based on the monomers constituting the acrylic polymer chains) from 0.05 to 5%, preferably 0.1 to 2.5% and particularly from 0.1 to 2.0%.

The acrylic polymer chain, Z, is formed from at least one mono olefinically unsaturated monomer which may be selected from any of the mono olefinically unsaturated monomers known in the art.

Suitable mono olefinically unsaturated monomers may be selected from the acrylic type monomers such as acrylic, methacrylic and chloroacrylic acids (i.e. CH₂=CHCICO.OH), acrylamide and methacrylamide, acrylonitrile and methacrylonitrile, alkoxyalkyl acrylamides and methacrylamides, e.g. butoxymethyl acrylamide and methoxymethyl methacrylamide, hydroxyalkyl acrylamides and methacrylamides, e.g. N-methylol acrylamide and methacrylamide, the metal acrylates and methacrylates, and the esters of acrylic, methacrylic and chloroacrylic acids with alcohols and phenols; the vinyl aromatic compounds, e.g. styrene and substituted derivatives thereof such as the halogenated derivatives thereof and vinyl toluene; the vinyl esters, e.g. vinyl acetate, and vinyl pyrrolidone.

A preferred mono olefinically unsaturated monomer is an acrylic or methacrylic acid ester having the formula CH₂=C(R)CO.OR² where R is H, methyl or n-butyl, especially methyl and n-butyl, and R² is optionally substituted hydrocarbyl (e.g. optionally halo or hydroxy substituted hydrocarbyl) and in particular is a C₁₋₈ alkyl, a C₆₋₁₀ cycloalkyl or a C₆₋₁₀ aryl group. Specific examples of such monomers include the non-substituted esters of acrylic and methacrylic acids such as methyl methacrylate, ethyl methacrylate, n-propyl methacrylate, isopropyl methacrylate, n-butyl methacrylate, isobutyl methacrylate, cyclohexyl methacrylate, isobomyl methacrylate, benzyl methacrylate, phenyl methacrylate and isobornyl acrylate and the substituted esters of acrylic and methacrylic acids such as hydroxyethyl methacrylate and hydroxypropyl methacrylate. More particularly, the mono olefinically unsaturated monomer incorporated in the polymerisable liquid is a C₁₋₈ alkyl ester of methacrylic acid. Methyl methacrylate and n-butyl methacrylate are especially preferred monomers.

The acrylic polymer chain, Z, may be formed from a mixture of mono olefinically unsaturated monomers, for example a mixture of the mono olefinically unsaturated monomers specified as preferred above.

The acrylic polymer chain, Z, may typically be formed from 10 to 1500, for example 25 to 1500, monomer units and preferably from 20 to 800 and particularly from 50 to 800 such units. When a mixture of monomer units is used, the copolymer may be a block or random copolymer of such units. Preferably the copolymer is a random copolymer as produced through conventional free radical polymerisation.

The acrylic polymer chain may be formed using the polythiol as a chain transfer agent through the polymerisation processes conventionally employed in the preparation of poly(methacrylates). Such processes include bulk, solution, emulsion and suspension polymerisation of the acrylic polymer chain. Preferably the process is a suspension polymerisation process.

When used, the suspension polymerisation process is typically conducted, at least initially, in the range 10 to 120° C., preferably in the range 50 to 110° C., particularly in the range 70 to 100° C. and especially about 80° C.

Preferred processes are bulk, solution, emulsion and suspension polymerisation processes which employ a free radical initiator.

Suitable free radical initiators include organic peroxides, hydroperoxides, persulphates and azo compounds. Examples of such initiators are methyl ethyl ketone peroxide, benzoyl peroxide, cumene hydroperoxide, potassium persulphate, azobisisobutyronitrile (AIBN), lauroyl peroxide, 2,5-dimethyl-2,5-di(t-butylperoxy) hexane, diethyl peroxide, dipropyl peroxide, dilauryl peroxide, dioleyl peroxide, distearyl peroxide, di(tertiary butyl) peroxide, di(tertiary amyl) peroxide, tertiary butyl hydroperoxide, tertiary amyl hydroperoxide, acetyl peroxide, propionyl peroxide, lauroyl peroxide, stearoyl peroxide, malonyl peroxide, succinyl peroxide, phthaloyl peroxide, acetyl benzoyl peroxide, propionyl benzoyl peroxide, ascaridole, ammonium persulphate, sodium persulphate, sodium percarbonate, potassium percarbonate, sodium perborate, potassium perborate, sodium perphosphate, potassium perphosphate, tetralin hydroperoxide, tertiary butyl diperphthalate, tertiary butyl perbenzoate, 2,4-dichlorobenzoyl peroxide, urea peroxide, caprylyl peroxide, p-chlorobenzoyl peroxide, 2,2-bis(tertiary butyl peroxy) butane, hydroxyheptyl peroxide.

It is preferred that the ratio of initiator to polythiol is less than 2:1 by weight, for example in the range 2:1 to 1:3, and particularly preferred that the ratio of initiator to polythiol is less than 5:1 on a molar basis, for example in the range 5:1 to 1:1.

When the polymerisation process is an emulsion polymerisation process the emulsifier may be chosen from those commonly used in the art. Such emulsifiers include fatty acid soaps, rosin soaps, sodium lauryl sulphate, polyethoxy alkylated phenols, dioctyl sodium sulphosuccinate and dihexyl sodium suiphosuccinate.

When the polymerisation process requires a solvent, such a solvent may be chosen from those commonly used in the art, for example benzene, toluene, xylene, aliphatic esters, naphthalene, trichlorobenzene and dimethylformamide. The volatile solvent may also be chosen from such solvents or others, for example aliphatic hydrocarbons, alcohols, ketones and ethers.

The present invention is illustrated by reference to the following examples.

General Preparation of Polythiol Capped Polymer

The following preparation was used to prepare a series of mono and polythiol capped polymers.

4.5 g of suspending agent (Natrosol HEC 250LR obtainable from Aqualon Inc, a division of Hercules Inc) were dissolved in 2.0 l of deionised water contained in a 5 litre flask by heating to a temperature in the range from 40 to 50° C. for 30 minutes whilst sparging with nitrogen and stirring at a speed of 1400 rpm.

A monomer premix was formed from 195 g of methyl methacrylate, 300 g of n-butyl methacrylate, 5 g of methacrylic acid, and the desired amount of mercaptan as indicated below. 4 g of AIBN initiator was washed into the deionised water using the premix whilst maintaining a nitrogen blanket and a water cooled reflux.

The temperature was raised to 76° C. The polymerisation proceeded through to almost completion conversion of monomer to polymer whereupon the cooling water to the condenser was stopped. The polymer was then heat treated by raising the temperature to within the range from 90 to 95° C. for 1 hour to complete the polymerisation or to drive off unreacted monomer.

After heat treating the polymer, the nitrogen blanket was removed and the polymer was air cooled.

The cooled polymer was then filtered, washed in deionised water and dried.

The examples are summarised as follows, wherein Examples 1 to 3 relate to polymers which can be used within the invention and Examples 4 to 6 relate to polymers which are used to provide comparative examples not according to the invention:

| | | Amount of Mercaptan | | | Amount of Initiator | | | Reaction |
|---|---|---|---|---|---|---|---|---|
| | | | | % w/w wrt | | | % w/w wrt | Time |
| Example | Mercaptan | g | moles ×10⁻² | monomer | g | moles ×10⁻² | monomer | (Minutes) |
| 1 | PETMP | 2.65 | 0.54 | 0.53 | 4.17 | 2.54 | 0.83 | 22 |
| 2 | PETMP | 6.64 | 1.36 | 1.33 | 4.17 | 2.54 | 0.83 | 26 |
| 3 | PETMP | 10.28 | 2.1 | 2.06 | 4.17 | 2.54 | 0.83 | 26 |
| 4 | DDM | 1.1 | 0.54 | 0.22 | 4.17 | 2.54 | 0.83 | 24 |
| 5 | DDM | 2.75 | 1.36 | 0.55 | 4.17 | 2.54 | 0.83 | 26 |
| 6 | DDM | 4.26 | 2.12 | 0.85 | 4.17 | 2.54 | 0.83 | 27 |

PETMP—pentaerythritol tetra (3-mercaptopropionate)—polythiol
DDM—dodecyl mercaptan—monothiol

The properties of the polymers from Examples 1 to 6 of solutions of the polymers in toluene are summarised below.

| | | | |
|---|---|---|---|
| | | | Melt |
| | GPC Data | Brookfield Viscosity | Flow |
| GPC Data | (Universal | in toluene @ 20° C. | Index |
| (PMMA Standards) | Calibration) | (cP) | g per |

| Ex | Mₙ | M_{w} | M_{w}/Mₙ | Mₙ | M_{w} | M_{w}/Mₙ | 30% | 40% | 50% | 56% | 10 mins |
|---|---|---|---|---|---|---|---|---|---|---|---|
| 1 | 31080 | 67840 | 2.18 | 80700 | 130900 | 1.62 | 122 | 860 | NTD | NTD | 5.58 |
| 2 | 21420 | 37240 | 1.74 | 47100 | 68800 | 1.46 | 50 | 228 | NTD | NTD | 24.8 |
| 3 | 14940 | 26250 | 1.76 | 36100 | 28600 | 1.26 | 34 | 120 | 1040 | 4000 | 49.2 |
| 4 | 34000 | 72700 | 2.14 | 86800 | 143100 | 1.65 | 160 | NTD | NTD | NTD | 5.29 |
| | | | | | | | (31) | | | | |
| 5 | 21870 | 43200 | 1.98 | 50900 | 79500 | 1.56 | 76 | 370 | NTD | NTD | 12.4 |
| | | | | | | | (52) | (62) | | | |
| 6 | 14630 | 31910 | 2.18 | 35800 | 55400 | 1.55 | 48 | 216 | NTD | NTD | 20.6 |
| | | | | | | | (41) | (80) | | | |

Note:
1. NTD—not totally dissolved
2. Melt Flow Index measured at 160° C. using 3.8 kg.
3. Brookfield viscosity is in respect of 30, 40, 50 and 56 g of polymer in 100 g of polymer and solvent.
4. The figures in brackets represent the % increase in viscosity when a monothiol is used.

It can therefore be seen that the polythiol capped polymers give rise to solutions which are less viscous than those formed from the same amount of monothiol capped polymers of comparable molecular weight and composition. Furthermore, a higher loading of polythiol capped polymer can be achieved. Conversely, the monothiol, from which is derived a linear polymer, is either not solvated or else provides a solution which has a viscosity that is at least 25%, preferably at least 30% and especially at least 40%, greater than the viscosity of a solution containing a comparable amount (on a molar basis) of polythiol capped polymer.

Of further note is that the polythiol capped polymers have inherently higher melt flow indices than the analogue monothiol capped polymers. Such properties also suggest their use in powder coating applications where a high melt flow index is desirable. Additionally, the polythiol capped polymers may also be useful in blends with other polymers in order to produce a blend having a reduced melt viscosity.

1. An acrylic polymer composition in the form of a coating or ink resin, which acrylic polymer composition contains
(a) a first amount of a polythiol capped polymer formed by reacting a polythiol of the form (HS-Y)ₙ- X wherein X is a core group each Y group is independently a linking group n is an integer from 3 to 8 with at least one non-substituted mono olefinically unsaturated monomer capable of attaching to and forming a group Z, which is an acrylic polymer chain, on the sulphur atom in each of the groups (HS-Y); and
(b) a second amount of a volatile solvent and wherein the polythiol capped polymer is differentiated from a linear polymer having the same molecular weight as the polythiol capped polymer and which linear polymer is formed from substantially the same each Z group as the polythiol capped polymer in that a first amount of the linear polymer is
(i) not totally solvated by the second amount of volatile solvent; or
(ii) when solvated by the second amount of volatile solvent provides a solution which has a viscosity that is at least 25%, preferably at least 30% and especially at least 40%, greater than the viscosity of the first amount of the polythiol capped polymer in the second amount of the volatile solvent.

2. An acrylic polymer composition as claimed in claim 1 wherein the first amount of the polythiol capped polymer and the second amount of volatile solvent are chosen to provide a solution which contains from 20 to 70 g of polythiol capped polymer per 100 g of polythiol capped polymer and volatile solvent.

3. An acrylic polymer composition as claimed in either claim 1 or claim 2 wherein the core group, X, is at least part of the residue of a tri- to octa-functional alcohol.

4. An acrylic polymer composition as claimed in claim 3 wherein the core group, X, is a residue of glycerol, sorbitol, pentaerythritol, trimethylolethane, trimethylolpropane, pentahydroxypentane, triquinoyl and inositol.

5. An acrylic polymer composition as claimed in any one of claims 1 to 4 wherein the linking group, Y, is alkylate.

6. An acrylic polymer composition as claimed in claim 5 wherein the linking group, Y, is C₂₋₁₀ alkylate.

7. An acrylic polymer composition as claimed in any one of claims 1 to 6 wherein the acrylic polymer chain, Z, is formed from 10 to 1500 monomer units.

8. An acrylic polymer composition as claimed in claim 7 wherein each acrylic polymer chain, Z, is formed from 25 to 1500 monomer units.

9. An acrylic polymer composition as claimed in any one of claims 1 to 8 wherein the volatile solvent is selected from benzene, tol,:ene, xylene, aliphatic esters, naphthalene, trichlorobenzene, dimethylformamide, aliphatic hydrocarbons, alcohols, ketones and ethers.
